(19) United States
(12) Patent Application Publication
(10) Pub. No.: US 2014/0227971 A1
(43) Pub. Date: Aug. 14, 2014

(54) USER TERMINAL AND METHOD FOR MUTUALLY BECOMING AWARE OF AWARENESS TARGET TERMINAL

(71) Applicant: ELECTRONICS AND TELECOMMUNICATIONS RESEARCH INSTITUTE, Daejeon-city (KR)

(72) Inventors: Ho-Joon PARK, Daejeon (KR); Kyung-Hee Lee, Daejeon (KR); Chae-Deok Lim, Daejeon (KR)

(73) Assignee: ELECTRONICS AND TELECOMMUNICATIONS RESEARCH INSTITUTE, Daejeon-city (KR)

(21) Appl. No.: 14/021,688

(22) Filed: Sep. 9, 2013

(30) Foreign Application Priority Data
Feb. 8, 2013 (KR) 10-2013-0014469

(51) Int. Cl. H04B 5/00

(52) U.S. Cl. CPC H04B 5/0081
USPC 455/41.1

(57) ABSTRACT

Disclosed herein are a user terminal for performing mutual awareness with an awareness target terminal located within a preset distance and a method for performing mutual awareness between a user terminal and an awareness target terminal located within a preset distance. The user terminal includes a signal generation unit and a magnetic field formation unit. The signal generation unit generates pulse signals. The magnetic field formation unit generates magnetic fields that correspond to the pulse signals and that generate induced currents in the awareness target terminal.

### CROSS-REFERENCE TO RELATED APPLICATION

This application claims the benefit of Korean Patent Application No. 10-2013-0014469, filed on Feb. 8, 2013, which is hereby incorporated by reference in its entirety into this application.

### BACKGROUND OF THE INVENTION

1. Technical Field

The present invention relates generally to a user terminal and method for mutually becoming aware of a target terminal and, more particularly, to an apparatus and method for determining the mutual locations of a user terminal and an awareness target terminal

2. Description of the Related Art

Currently, thanks to the development of information and communication technology, most people carry personal mobile terminals, such as smart phones or tablet personal computers (PC). The users of such personal mobile terminals use a communication technique, such as ad hoc or Bluetooth in order to connect the terminals with each other. However, this scheme is problematic in that it is not easy to transmit even simple data.

Furthermore, the above communication techniques suffer from difficulty obtaining mutual location information when two or more terminals are combined and then used for other purposes. For example, there are cases in which the screens of two or more personal mobile terminals are connected and expanded in a manner similar to that in which two or more monitors are connected and then used in connection with a PC. In this case, when the settings of the terminals are processed using a Bluetooth or ad hoc communication technique, it is very difficult to represent information about the mutual information of the terminals. In this case, if it is possible to determine location information, such as on the left of, on the right of, above, or below a counterpart terminal, in advance, it becomes easy to implement the application. Furthermore, in the case where two or more terminals overlay each other or are successively arranged, multiple settings are required because of the difficulty in representing location information using a conventional method when mutual information transfer between the terminals is performed for a specific purpose. Furthermore, it is difficult for terminals that are used for a limited purpose, such as group communication terminals or digital walkie-talkies, to exchange information without using location information.

In connection with this, there is U.S. Patent Application Publication No. 2009-0029646 entitled “Communications Device, a System and Method using Inductive Communication.”

### SUMMARY OF THE INVENTION

Accordingly, the present invention has been made keeping in mind the above problems occurring in the conventional art, and an object of the present invention is to provide an apparatus and method that can become aware of an awareness target terminal when a user terminal and the awareness target terminal are located within a preset distance and that can determine the mutual locations of the user terminal and the awareness target terminal.

In accordance with an aspect of the present invention, there is provided a user terminal for performing mutual awareness with an awareness target terminal located within a preset distance, including a signal generation unit configured to generate pulse signals; and a magnetic field formation unit configured to generate magnetic fields that correspond to the pulse signals and that generate induced currents in the awareness target terminal.

The user terminal may further include a determination unit configured to determine a location of the awareness target terminal based on the induced currents when the induced currents flow through the field formation unit of the user terminal in response to the magnetic fields that are generated in the awareness target terminal.

The magnetic field formation unit may include a first electric coil that is disposed on the first surface of the user terminal to be spaced.

The magnetic field formation unit may further include a second electric coil that is disposed on the second surface of the user terminal to be spaced, the second surface being opposite the first surface.

The magnetic field formation unit may further include a third electric coil that is disposed on the third surface of the user terminal to be spaced, the third surface connecting one end of the first surface with one end of the second surface.

The magnetic field formation unit may further include a fourth electric coil that is disposed on the fourth surface of the user terminal to be spaced, the fourth surface being opposite the third surface.

The signal generation unit may transmit different pulse signals to one or more of first, second, third and fourth electric coils, and the first, second, third and fourth electric coils may generate different magnetic fields in response to the different pulse signals.

In accordance with an aspect of the present invention, there is provided a method for performing mutual awareness between a user terminal and an awareness target terminal located within a preset distance, including generating, by a signal generation unit of the user terminal, pulse signals; and generating, by a magnetic field formation unit of the user terminal, magnetic fields that correspond to the pulse signals and that generate induced currents in the awareness target terminal.

The method may further include determining, by a determination unit of the awareness target terminal, a location of the user terminal based on the induced currents when the induced currents flow through a field formation unit of the awareness target terminal in response to the magnetic fields that are generated upon generating the magnetic fields.

Generating the magnetic fields may include generating the magnetic fields using the magnetic field formation unit that includes a first electric coil that is disposed on a first surface of the user terminal to be spaced.

Generating the magnetic fields may include generating the magnetic fields using the magnetic field formation unit that further includes a second electric coil that is disposed on a second surface of the user terminal to be spaced, the second surface being opposite the first surface.

Generating the magnetic fields may include generating the magnetic fields using the magnetic field formation unit that further includes a third electric coil that is disposed on the third surface of the user terminal to be spaced, the third surface connecting one end of the first surface with one end of the second surface.

Generating the magnetic fields may include generating the magnetic fields using the magnetic field formation unit that further includes a fourth electric coil that is disposed on the fourth surface of the user terminal to be spaced, the fourth surface being opposite the third surface.

Generating the pulse signals may include transmitting different pulse signals to one or more of first, second, third and fourth electric coils; and generating the magnetic fields may include generating, by the first, second, third and fourth electric coils, the different magnetic fields in response to the different pulse signals.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a user terminal according to an embodiment of the present invention;

FIG. 2 is a diagram illustrating the process of the mutual awareness between a user terminal and an awareness target terminal according to an embodiment of the present invention;

FIG. 3 illustrates an example of the locations of electric coils included in the user terminal according to an embodiment of the present invention;

FIG. 4 is a flowchart illustrating a process of determining the mutual locations of a user terminal and an awareness target terminal according to an embodiment of the present invention; and

FIG. 5 is a flowchart illustrating step S110 of FIG. 4 in greater detail.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

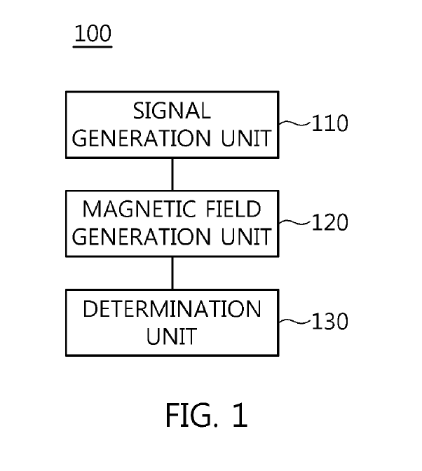

A user terminal 100 according to an embodiment of the present invention will be described with reference to FIG. 1. FIG. 1 is a block diagram of the user terminal 100 according to this embodiment of the present invention. The user terminal 100 includes a signal generation unit 110, a magnetic field formation unit 120, and a determination unit 130. The components included in the user terminal 100 will be described below. Furthermore, it should be appreciated that in the following description, the user terminal 100 and an awareness target terminal include the above-described same configuration. That is, although the user terminal 100 and the awareness target terminal are distinguished from each other in order to help an understanding of the present invention in the specification, these terminals have the same configuration.

The signal generation unit 110 functions to generate pulse signals and transmit the generated pulse signals to the magnetic field formation unit 120. In this case, the pulse signals are transmitted to a plurality of electric coils that are included in the magnetic field formation unit 120. Furthermore, the pulse signals to be transmitted to the plurality of electric coils may have different pulse frequencies, respectively. This enables the plurality of electric coils to be distinguished from each other.

The magnetic field formation unit 120 functions to generate magnetic fields. In this case, the magnetic fields are generated in response to the pulse signals that are transmitted by the signal generation unit 110. These magnetic fields generate induced currents in electric coils that are included in the awareness target terminal.

The magnetic field formation unit 120 includes the plurality of electric coils. In this case, the plurality of electric coils may be disposed on respective surfaces of the user terminal 100 to be spaced. Furthermore, the plurality of electric coils receives the pulse signals from the signal generation unit 110, in which case the pulse signals having different pulse frequencies are transmitted to the plurality of electric coils, respectively. For example, it is assumed that there are four electric coils, that is, first, second, third and fourth electric coils. In this example, the signal generation unit 110 transmits different pulse signals to the first, second, third and fourth electric coils. For example, the signal generation unit 110 may transmit 11 Hz, 3 Hz, 7 Hz and 2 Hz pulse signals to the first, second, third and fourth electric coils, respectively. This enables the first, second, third and fourth electric coils to generate different magnetic fields. Accordingly, when the awareness target terminal approaches the user terminal 100, the surface of the user terminal 100 to which the awareness target terminal 200 is proximate may be determined based on the different magnetic fields.

Furthermore, the magnetic field formation unit 120 of the user terminal 100 generates induced currents when magnetic fields are generated by the awareness target terminal 200. This enables induced currents to be generated in the magnetic field formation unit of the user terminal 100 when the awareness target terminal 200 approaches one of the surfaces of the user terminal 100.

The determination unit 130 determines whether the user terminal 100 and the awareness target terminal 200 are located within a preset range and induced currents flow through the magnetic field formation unit 120 of the user terminal 100 because of magnetic fields that are generated in the awareness target terminal 200. In this case, when the induced currents flow through the magnetic field formation unit 120 of the user terminal 100, it is determined based on these induced currents that the awareness target terminal is proximate to the user terminal 100. Furthermore, as described above, the plurality of electric coils is disposed on respective surfaces of the terminal to be spaced. Since the plurality of electric coils generates different magnetic fields in response to different pulse signals, the user terminal 100 may determine the mutual locations of the awareness target terminal and the user terminal 100 based on the induced currents that are generated by the generated magnetic fields.

Furthermore, the induced currents flowing through the magnetic field formation unit 120 may be influenced by the magnetic fields that are generated in the first and third electric coils of the awareness target terminal. In this case, the determination unit 130 may select an electric coil that influences the magnetic field formation unit 120 of the user terminal 100 more than the others. More specifically, the determination unit 130 may compare the induced currents generated by the first and third electric coils of the awareness target terminal with each other, and may then select an electric coil based on the induced currents. Accordingly, the determination unit 130 may determine the mutual locations of the terminals based on a magnetic field that belongs to the magnetic fields generated by the first and third electric coils of the awareness target terminal and that influences the user terminal 100 more than the other magnetic field.

Furthermore, the determination unit 130 further determines whether currents flowing through the magnetic field formation unit 120 are currents generated by the signal generation unit 110 itself or induced currents generated by the awareness target terminal. This enables the user terminal 100 to reduce the possibility of erroneously becoming aware of the awareness target terminal.

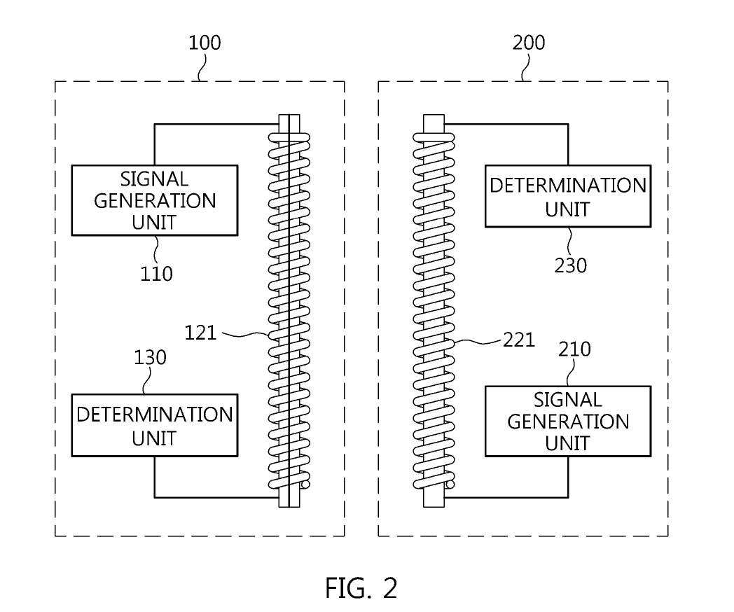

The process of the mutual awareness of the user terminal 100 and the awareness target terminal 200 will be described with reference to FIG. 2 below. FIG. 2 is a diagram illustrating the process of mutual awareness between the user terminal 100 and the awareness target terminal 200 according to an embodiment of the present invention. Although only one electric coil 121 of the user terminal and only one electric coil 221 of the awareness target terminal 200 have been illustrated in FIG. 2, it should be appreciated that this illustration is intended merely to help an understanding, and the number of electric coils 121 is not limited thereto.

First, the signal generation unit 110 of the user terminal 100 generates pulse signals. The pulse signals are transmitted to the electric coils 121 that are included in the magnetic field formation unit 120, as described above.

The electric coils 121 generate magnetic fields corresponding to the pulse signals when receiving the pulse signals from the signal generation unit 110.

Thereafter, when the awareness target terminal 200 is located within the preset range, that is, the magnetic field range, of the user terminal 100, induced currents flow through the electric coil 221 of the awareness target terminal 200 in response to the magnetic fields.

Thereafter, the determination unit 230 of the awareness target terminal 200 may determine that the user terminal 100 and the awareness target terminal 200 are currently proximate to each other based on the magnitude of induced currents. Furthermore, since the electric coils 121 generates magnetic fields in response to different pulse signals depending on the locations thereof, as described above, the locations of the terminals may be determined via the magnitude of the induced currents based on the magnetic fields.

In the description given with reference to FIG. 2, the awareness target terminal 200 has been described as determining the location based on the magnetic fields that are generated by the user terminal 100. The above-described operation may be performed by the user terminal, and thus the user terminal 100 and the awareness target terminal 200 may determine the locations of each other.

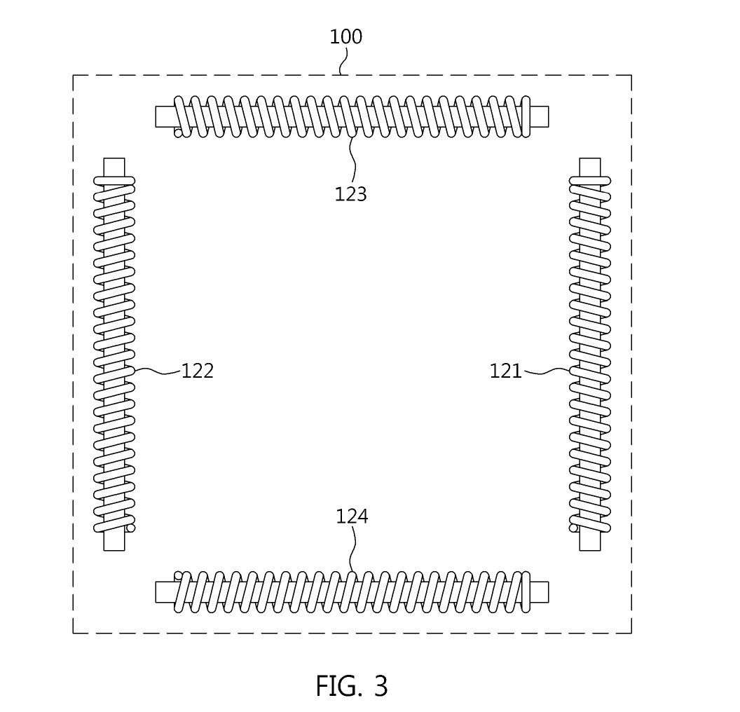

An example of the arrangement of the electric coils included in the user terminal 100 will be described with reference to FIG. 3. FIG. 3 illustrates an example in which four electric coils are arranged in the user terminal 100.

As described with reference to FIG. 1, the user terminal 100 includes the magnetic field formation unit 120. Furthermore, the magnetic field formation unit 120 includes a plurality of electric coils including a first electric coil 121, a second electric coil 122, a third electric coil 123, and a fourth electric coil 124.

In the example illustrated in FIG. 3, the first electric coil 121 is disposed on one surface of the user terminal 100 to be spaced. The second electric coil 122 is disposed on a surface to be spaced, the surface being a second surface and opposite the first surface. The third electric coil 123 is disposed on a third surface to be spaced, the third surface connecting one end of the first surface with one end of the second surface. The fourth electric coil 124 is disposed on a third surface to be spaced, the third surface being opposite the fourth surface. In this case, it should be appreciated that the locations of the first, second, third and fourth electric coils 121, 122, 123 and 124 are not limited to those of this example and are variable depending on the needs of a user.

The first, second, third and fourth electric coils 121, 122, 123 and 124 receive different pulse signals from the signal generation unit 110 illustrated in FIG. 1, and generate different magnetic fields, as described above. For example, 11 Hz, 3 Hz, 7 Hz and 2 Hz pulse signals may be transmitted to the first, second, third, and fourth electric coils, and may generate different magnetic fields in respective electric coils. Accordingly, when induced currents flow through the awareness target terminal because of magnetic fields that are generated by the first, second, third and fourth electric coils 121, 122, 123 and 124, the mutual locations of the user terminal 100 and the awareness target terminal may be determined based on the magnitude of the induced currents.

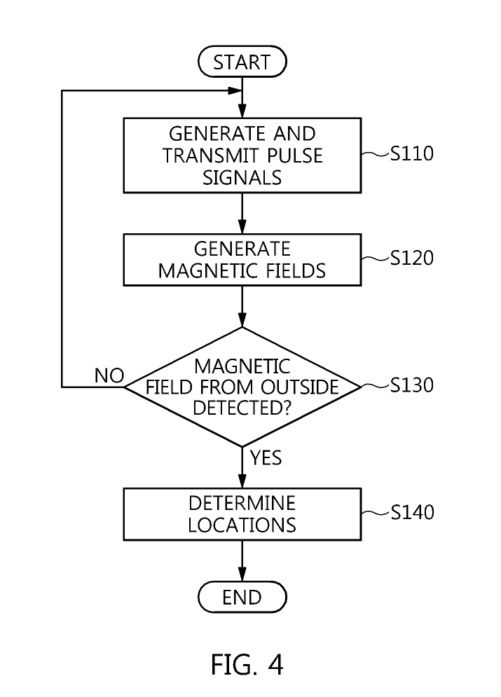

A method of determining the mutual locations of a user terminal and an awareness target terminal will be described with reference to FIG. 4. FIG. 4 is a flowchart illustrating a process in which an awareness target terminal determines the location of a user terminal according to an embodiment of the present invention. In the following description, redundant descriptions that are the same as the foregoing descriptions will be omitted in order to make the specification clearer.

First, step S110 at which the signal generation unit of the user terminal generates pulse signals and transmits the generated pulse signals to the magnetic field formation unit is performed. The pulse signals generated at step S110 are transmitted to the respective electric coils included in the magnetic field formation unit. In this case, the pulse signals transmitted to the plurality of electric coils have different pulse frequencies. For example, if it is assumed that the number of electric coils is 4, pulse signals transmitted to these electric coils may be 11 Hz, 3 Hz, 7 Hz and 2 Hz pulse signals. In this case, it should be appreciated that the frequencies of the pulse signals are merely examples and are not limited thereto.

Thereafter, step S120 at which the magnetic field formation unit of the user terminal generates magnetic fields corresponding to pulse signals transmitted at step S110 is performed. The magnetic fields generated at step S120 function to generate induced currents in the awareness target terminal as described above. As described at step S110, the magnetic field formation unit includes the plurality of electric coils, and different pulse signals are transmitted to the respective electric coils. The plurality of electric coils generates different magnetic fields in response to the pulse signals.

As described with reference to FIG. 1, the user terminal may perform the function of determining the location of the awareness target terminal based on the magnetic fields generated in the awareness target terminal, as well as the function of generating magnetic fields. This will be described in conjunction with steps S130 and S140.

At step S130, it is determined whether the magnetic fields generated by the awareness target terminal have been detected. If it is determined at step S130 that magnetic fields have been detected, the control proceeds to step S140. If it is determined at step S130 that magnetic fields have been detected, the control returns to step S110.

At step S140, the location of the awareness target terminal is determined based on the magnetic fields detected at step S130. As described with reference to FIG. 1, if the magnetic fields are generated in the awareness target terminal, and the user terminal and the awareness target terminal are located within the preset range, induced currents flow through the magnetic field formation unit of the user terminal. Accordingly, at step S140, the magnitude of the induced current may be detected by the determination unit included in the user terminal, and the location of the awareness target terminal may be determined based on the results of the detection. Steps S110 to S140 may be performed by the awareness target terminal in a similar manner and the awareness target terminal may also determine the location of the user terminal.

Furthermore, at step S140, it is further determined whether the currents flowing through the magnetic field formation unit of the user terminal are currents generated by the signal generation unit of the user terminal itself or induced currents generated by the awareness target terminal. Step S140 may reduce the possibility of erroneously becoming aware of the awareness target terminal.

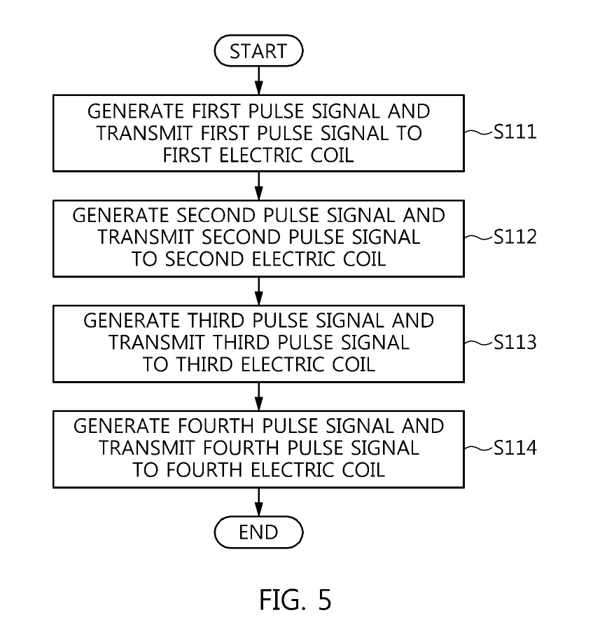

Step S110 of FIG. 4 will be described in greater detail with reference to FIG. 5. FIG. 5 is a flowchart illustrating the pulse signal generation and transmission step of FIG. 4 in greater detail.

At step S111, the signal generation unit of the user terminal generates a first pulse signal to be transmitted to the first electric coil, and transmits the first pulse signal to the first electric coil.

At step S112, the signal generation unit of the user terminal generates a second pulse signal to be transmitted to the second electric coil, and transmits the second pulse signal to the second electric coil.

At step S113, the signal generation unit of the user terminal generates a third pulse signal to be transmitted to the third electric coil, and transmits the third pulse signal to the third electric coil.

At step S114, the signal generation unit of the user terminal generates a fourth pulse signal to be transmitted to the fourth electric coil, and transmits the fourth pulse signal to the fourth electric coil.

The first, second, third and fourth pulse signals generated at steps S111 to S114 are pulse signals with different pulse frequencies. For example, the first, second, third and fourth pulse signals may be 11 Hz, 3 Hz, 7 Hz, and 2 Hz pulse signals, respectively. In this case, it should be appreciated that the pulse signals are not limited to the above-described frequencies. Based on the different pulse signals generated at steps S111 to S114, different magnetic fields are generated in the first, second, third and fourth electric coils included in the magnetic field formation unit of the user terminal.

The user terminal and mutual awareness method according to the present invention is advantageous in that the awareness target terminal can be notified of the current location of the user terminal and the portion of the awareness target terminal that is proximate to the user terminal can be determined.

Furthermore, the user terminal and mutual awareness method according to the present invention has the advantage of determining the mutual locations of the awareness target terminal and the user terminal.

Furthermore, the user terminal and mutual awareness method according to the present invention is advantageous in that separate actions may be taken with three or more terminals disposed in close proximity in each other and in that new applications can be made based on the determination of the mutual locations of terminals in various fields of application, such as game terminals.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A user terminal for performing mutual awareness with an awareness target terminal located within a preset distance, comprising:
a signal generation unit configured to generate pulse signals; and
a magnetic field formation unit configured to generate magnetic fields that correspond to the pulse signals and that generate induced currents in the awareness target terminal.

2. The user terminal of claim 1, further comprising a determination unit configured to determine a location of the awareness target terminal based on the induced currents when the induced currents flow through the field formation unit of the user terminal in response to the magnetic fields that are generated in the awareness target terminal.

3. The user terminal of claim 2, wherein the magnetic field formation unit comprises a first electric coil that is disposed on a first surface of the user terminal to be spaced.

4. The user terminal of claim 3, wherein the magnetic field formation unit further comprises a second electric coil that is disposed on a second surface of the user terminal to be spaced, the second surface being opposite the first surface.

5. The user terminal of claim 4, wherein the magnetic field formation unit further comprises a third electric coil that is disposed on a third surface of the user terminal to be spaced, the third surface connecting one end of the first surface with one end of the second surface.

6. The user terminal of claim 5, wherein the magnetic field formation unit further comprises a fourth electric coil that is disposed on a fourth surface to be spaced, the fourth surface being opposite the third surface.

7. The user terminal of claim 6, wherein the signal generation unit transmits different pulse signals to one or more of first, second, third and fourth electric coils, and the first, second, third and fourth electric coils generate different magnetic fields in response to the different pulse signals.

8. A method for performing mutual awareness between a user terminal and an awareness target terminal located within a preset distance, comprising:
generating, by a signal generation unit of the user terminal, pulse signals; and
generating, by a magnetic field formation unit of the user terminal, magnetic fields that correspond to the pulse signals and that generate induced currents in the awareness target terminal.

9. The method of claim 8, further comprising determining, by a determination unit of the awareness target terminal, a location of the user terminal based on the induced currents when the induced currents flow through a field formation unit of the awareness target terminal in response to the magnetic fields that are generated upon generating the magnetic fields.

10. The method of claim 9, wherein generating the magnetic fields comprises generating the magnetic fields using the magnetic field formation unit that comprises a first electric coil that is disposed on a first surface of the user terminal to be spaced.

11. The method of claim 10, wherein generating the magnetic fields comprises generating the magnetic fields using the magnetic field formation unit that further comprises a second electric coil that is disposed on a second surface of the user terminal to be spaced, the second surface being opposite the first surface.

12. The method of claim 11, wherein generating the magnetic fields comprises generating the magnetic fields using the magnetic field formation unit that further comprises a third electric coil that is disposed on a third surface of the user terminal to be spaced, the third surface connecting one end of the first surface with one end of the second surface.

13. The method of claim 12, wherein generating the magnetic fields comprises generating the magnetic fields using the magnetic field formation unit that further comprises a fourth electric coil that is disposed on a fourth surface of the user terminal to be spaced, the fourth surface being opposite the third surface.

14. The method of claim 13, wherein:
generating the pulse signals comprises transmitting different pulse signals to one or more of first, second, third and fourth electric coils; and
generating the magnetic fields comprises generating, by the first, second, third and fourth electric coils, the different magnetic fields in response to the different pulse signals.
